(19) United States
(12) Patent Application Publication
(10) Pub. No.: US 2009/0152275 A1
(43) Pub. Date: Jun. 18, 2009

(54) VEHICLE WASHER TANK AND METHOD FOR PREPARING WASHER FLUID

(75) Inventor: Hiroshi Matsumoto, Hamamatsu-shi (JP)

Correspondence Address: MARSH, FISCHMANN & BREYFOGLE LLP, 8055 East Tufts Avenue, Suite 450, Denver, CO, 80237, US

(73) Assignee: ASMO CO., LTD., Kosai-shi (JP)

(21) Appl. No.: 12/325,947

(22) Filed: Dec. 1, 2008

(30) Foreign Application Priority Data
Dec. 3, 2007 (JP) 2007-312246

(51) Int. Cl. B65D 25/00; C11D 3/00

(52) U.S. Cl. 220/564; 220/562; 510/181

(57) ABSTRACT

A vehicle washer tank including a solid washer agent accommodated in the washer tank. The washer agent contains an undiluted washer fluid component and dissolves in water.

### BACKGROUND OF THE INVENTION

The present invention relates to a vehicle washer tank for storing washer fluid and a method for preparing the washer fluid.

Vehicles are provided with windshield washer tanks for storing windshield washer fluid. Japanese Laid-Open Patent Publication No. 5-238358 describes an example of such a windshield washer tank. Undiluted windshield washer fluid may be mixed with water, which is stored in the washer tank, to prepare the windshield washer fluid for use.

In a vehicle production line, the washer tank is fixed to the vehicle body. The washer tank is thereafter filled with windshield washer fluid (mixture of undiluted windshield fluid and water). In this manner, before production of the vehicle is completed, the windshield washer fluid is stored in the washer tank, and tests are conducted to check that the washer fluid can be ejected by a pump in a normal manner.

In the above case, a ready-made windshield washer fluid, which has already been diluted with water, or undiluted windshield washer fluid must be transported to, for example, the production line in a plant. However, fluids, such as the ready-made washer fluid or undiluted windshield washer fluid, are heavy and voluminous and thus difficult to handle. This increases transportation costs.

### SUMMARY OF THE INVENTION

It is an object of the present invention to provide a vehicle washer tank and a method for preparing the washer fluid that lowers the transportation cost of the washer fluid.

One aspect of the present invention is a vehicle washer tank including a solid washer agent accommodated in the washer tank. The washer agent contains an undiluted washer fluid component and dissolves in water.

A further aspect of the present invention is a method for producing washer fluid stored in a vehicle washer tank. The method includes preparing a solid washer agent which includes undiluted washer fluid and dissolves in water, accommodating the washer agent in the washer tank, and pouring water into the washer tank to dissolve the washer agent and produce the washer fluid.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing a preferred embodiment of a washer tank according to the present invention; and

FIG. 2 is a schematic diagram showing a further embodiment of a washer tank according to the present invention.

### DETAILED DESCRIPTION OF THE PREFERRED EMBODIMENTS

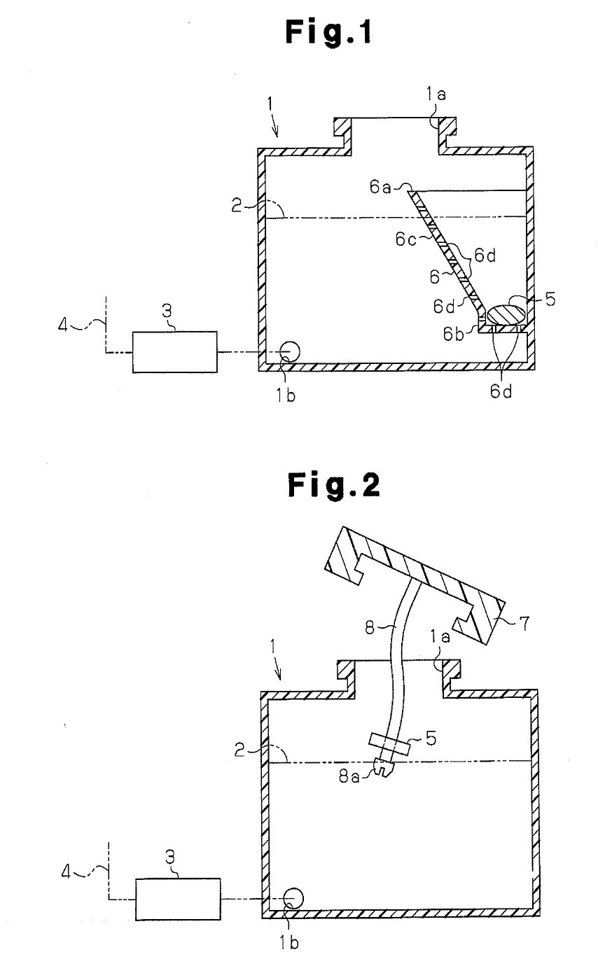

A preferred embodiment of the present invention will now be discussed with reference to FIG. 1.

As shown in FIG. 1, a windshield washer tank 1 is formed so that it can store windshield washer fluid 2 (shown in the drawings by a broken line).

A fluid filler opening 1a is formed in the central top portion (an end portion in a direction opposite to a gravity direction) of the washer tank 1. A pump port 1b is formed in a lower portion (an end portion in the gravity direction) of the washer tank 1, more specifically, in a side wall of the washer tank 1 near the tank bottom. An electric pump 3 is connected to the pump port 1b. The electric pump 3 draws out the washer fluid 2 from the lower portion of the washer tank 1 and delivers the washer fluid 2 to washer nozzles through a pump hose 4.

A holder 6, which can hold a windshield washer agent 5, is formed in the washer tank 1. The washer agent 5 is a solid that includes undiluted windshield washer fluid components and dissolves in water.

In detail, the undiluted windshield washer fluid components include optimal materials for producing windshield washer fluid when diluted with water, such as surfactant, a colorant, and methanol. The washer agent 5 is formed by solidifying the afore-mentioned materials or containing the aforementioned material in a capsule that dissolves in water. In this embodiment, the washer agent 5 is formed as a tablet that contains a plurality of materials.

In the washer tank 1, the holder 6 extends from an inner side surface of the washer tank 1 so as to define a holder opening 6a that opens in an upward direction. The holder opening 6a extends to the central portion of the washer tank 1 so as to partially overlap with the fluid filler opening 1a when viewed from above (so as to be visible from the fluid filler opening 1a). In more detail, the holder 6 includes an accommodation portion 6b, which is formed at the bottom part of the holder 6, and sloped portion 6c, which extends diagonally upward from the accommodation portion 6b. The accommodation portion 6b, the size of which is substantially the same as the washer agent 5, accommodates the washer agent 5 so as to restrict movement of the washer agent 5 in a direction perpendicular to the vertical direction. The sloped portion 6c extends diagonally upward from the accommodation portion 6b toward the fluid filler opening 1a when viewed from above. The sloped portion 6c has an upper end that defines the holder opening 6a.

The accommodation portion 6b is spaced from the bottom of the washer tank 1 so that it can hold the washer agent 5 at a position spaced from the bottom of the washer tank 1. The elevation of the accommodation portion 6b from the bottom of the washer tank 1 is set so that the washer agent 5 dissolves in a satisfactory manner (tolerable concentration range even if the concentration is high) when water reaches the washer agent 5. More specifically, if an adequate amount of water for a single tablet were to be one to four liters, in a state in which a single tablet of the washer agent 5 is accommodated in a four-liter washer tank 1, the elevation of the accommodation portion 6b would be set so that the washer agent 5 becomes submerged when the washer tank 1 contains one liter of water.

The accommodation portion 6b and the sloped portion 6c each include an inner surface, which defines a holding cavity for holding the washer agent 5, and an opposite outer surface. A plurality of small holes 6d extend from the inner surface to the outer surface in the accommodation portion 6b and the sloped portion 6c. The small holes 6d are each smaller than the washer agent 5. The washer agent 5 is dropped into the holder opening 6a through the fluid filler opening 1a. Then, the washer agent 5 slides down along the sloped portion 6c to be accommodated and held in the accommodation portion 6b.

In a state accommodating the washer agent 5 as described above, the washer tank 1 is fixed to a vehicle body (not shown) during a fastening operation performed in a vehicle production line. Then, in a water filling operation, water is filled into the washer tank 1 to produce the windshield washer fluid 2. That is, the washer agent 5 accommodated in the washer tank 1 is submerged and dissolves in water so as to produce the windshield washer fluid 2. Subsequently, in a testing operation, a test is conducted to check that the electric pump 3 ejects the windshield washer fluid 2 in a normal manner.

When the washer fluid 2 prepared as discussed above is totally consumed, for example, the user drops a new washer agent 5 into the holder 6 and pours water into the washer tank 1 to produce the washer fluid 2.

The preferred embodiment has the advantages described below.

(1) The washer tank 1 accommodates the washer agent 5, which is a solid containing undiluted washer fluid components and dissolves in water. Thus, the washer fluid 2 is produced just by pouring water into the washer tank 1. This eliminates the need for the transportation of fluids, such as a ready-made washer fluid or undiluted windshield washer fluid, and thereby reduces transportation costs. Since tap water can be used as the water that fills the washer tank 1, there is normally no need to transport the water.

(2) The washer agent 5 is held by the holder 6 in the washer tank 1. This prevents the washer agent 5 from moving (rolling) in the washer tank 1. Thus, abnormal noise is prevented from being produced. Further, since the washer agent 5 does not move (roll) and hit the wall of the washer tank 1, the washer agent 5 is prevented from being cracked or broken (if the washer agent 5 is a capsule, the capsule is prevented from opening).

(3) The washer agent 5 is held at a position spaced from the bottom of the washer tank 1. Thus, the washer agent 5 is not submerged in water when the washer tank 1 contains only a small amount of water. The washer agent 5 starts to dissolve only when the washer tank 1 contains at least a predetermined amount of water. Thus, when the washer tank 1 contains only a small amount of water, a washer fluid having a viscosity that is abnormally high and a washer undiluted fluid component concentration that is excessively high is prevented from being produced. If the viscosity of the washer fluid were to be excessively high, this may lead to clogging (ejection problems) of the electric pump 3. However, the preferred embodiment prevents such clogging.

(4) The holder opening 6a is formed so as to partially overlap with the fluid filler opening 1a when viewed from above (so as to be visible from the fluid filler opening 1a). Thus, the washer agent 5 can be easily dropped into the holder opening 6a while looking into the fluid filler opening 1a. This facilitates the arrangement of the washer agent 5 in the holder 6.

(5) The holder 6 includes an inner surface, which defines a holding cavity for holding the washer agent 5, and an opposite outer surface. The small holes 6d extend through the holder 6 from the inner surface to the outer surface. The small holes 6d are each smaller than the washer agent 5. Thus, when water is poured into the washer tank 1, water easily moves between the inside and outside of the holding cavity in the holder 6. This dissolves the washer agent 5 in a satisfactory manner.

It should be apparent to those skilled in the art that the present invention may be embodied in many other specific forms without departing from the spirit or scope of the invention. Particularly, it should be understood that the present invention may be embodied in the following forms.

In the preferred embodiment, the holder 6 is formed inside the washer tank 1. However, the present invention is not limited in such a manner. For example, the holder 6 may be eliminated from the washer tank 1. That is, the washer tank 1 may hold the washer agent 5 without the holder 6.

In the preferred embodiment, the holder opening 6a of the holder 6 is formed so as to partially overlap with the fluid filler opening 1a when viewed from above (so as to be visible from the fluid filler opening 1a). However, the present invention is not limited in such a manner, and the holder opening 6a may be formed so that it does not overlap with the fluid filler opening 1a when viewed from above.

In the preferred embodiment, the holder 6 includes the small holes 6d. However, the present invention is not limited in such a manner. For example, the small holes 6d may be eliminated from the holder 6 and the elevation of the holder opening 6a may be lowered from that of the preferred embodiment. In this case, the elevation of the holder opening 6a is set so that when the level of the water poured into the washer tank 1 reaches the holder opening 6a, the washer agent 5 starts to dissolve in a satisfactory manner (tolerable concentration range even if the concentration is high). In other words, the holder 6 may be formed so that it includes only the accommodation portion 6b (does not include the sloped portion 6c) of the preferred embodiment.

In the preferred embodiment, the washer agent 5 is a tablet but may be any kind of solid that dissolves in water and produces windshield washer fluid. For example, the washer agent 5 may be a capsule or powder that dissolves in water.

In the preferred embodiment, the holder 6 is formed integrally with the washer tank 1. However, the present invention is not limited in such a manner. For example, as shown in FIG. 2, the washer tank 1 may include a cap 7 and a holder 8. The cap 7 is detachably attached to the washer tank 1 so as to enable opening and closing of the fluid filler opening 1a. The holder 8 is formed by a cord extending from the cap 7. A hook 8a is arranged on the distal end of the holder 8. The washer agent 5 is annular and held near the distal end of the holder 8 in a state hooked to the hook 8a. The holder 8 has a length that is set so that when the cap 7 is attached to the washer tank 1, the washer agent 5 is held at a position spaced from the bottom of the washer tank 1. In this manner, the holder 8, which holds the washer agent 5, may be detachable from the washer tank 1. The holder 8 may be a flexible cord or a relatively rigid rod. Further, a cord-like level gauge may be connected to the cap 7 to check the liquid level of the washer fluid 2. The gauge may also be used to support the holder 8.

In this case, the structure of the washer tank 1 is simplified compared to the preferred embodiment illustrated in FIG. 1 in which the holder 6 is formed inside and integrally with the washer tank 1. Thus, the washer tank 1 may be, for example, blow-molded. This facilitates the manufacturing of the washer tank 1 and lowers costs. In addition, the conventional tank that does not include a holder may be used as the washer tank 1. This enables the washer tank 1 to be standardized.

The present examples and embodiments are to be considered as illustrative and not restrictive, and the invention is not to be limited to the details given herein, but may be modified within the scope and equivalence of the appended claims.

What is claimed is:

1. A vehicle washer tank comprising:
a solid washer agent accommodated in the washer tank, in which the washer agent contains an undiluted washer fluid component and dissolves in water.

2. The washer tank according to claim 1, further comprising:
a holder which is arranged in the washer tank and holds the washer agent.

3. The washer tank according to claim 2, wherein the holder holds the washer agent at a position spaced from a bottom of the washer tank.

4. The washer tank according to claim 3, wherein the washer agent is held by the holder at an elevation that is set so that when water in the washer tank reaches the washer agent, the washer agent dissolves in water and produces washer fluid having a concentration that is in a tolerable range.

5. The washer tank according to claim 2, further comprising:
a fluid filler opening which opens upward; and
a holder opening which opens upward in the holder, wherein the holder opening at least partially overlaps the fluid filler opening when viewed from above.

6. The washer tank according to claim 2, wherein the holder includes an accommodation portion, which is formed at a bottom part of the holder, and a sloped portion, which extends diagonally upward from the accommodation portion, in which the accommodation portion accommodates the washer agent in a manner restricting movement in the horizontal direction, and the sloped portion includes an upper end that defines the holder opening.

7. The washer tank according to claim 2, wherein the holder includes an inner surface defining a holding cavity for holding the washer agent, an opposite outer surface, and a hole extending through the holder from the inner surface to the outer surface, in which the hole is smaller than the washer agent.

8. The washer tank according to claim 2, wherein the holder is formed integrally with a side wall of the washer tank.

9. The washer tank according to claim 2, further comprising:
a fluid filler opening; and
a cap which is detachably attached to the washer tank so as to enable opening and closing of the fluid filler opening, wherein the holder is arranged on the cap.

10. A method for producing washer fluid stored in a vehicle washer tank, the method comprising:
preparing a solid washer agent which includes undiluted washer fluid and dissolves in water;
accommodating the washer agent in the washer tank; and
pouring water into the washer tank to dissolve the washer agent and produce the washer fluid.
